(19) United States
(12) Patent Application Publication
(10) Pub. No.: US 2010/0089551 A1
(43) Pub. Date: Apr. 15, 2010

(54) AMINOPLASTIC-BASED, LIQUID-IMPREGNATED FOAMED PLASTIC PART AND USES THEREOF

(76) Inventors: Hans-Jürgen Quadbeck-Seeger, Bad Durkheim (DE); Armin Alteheld, Bad Kreuznach (DE); Klaus Hahn, Kirchheim (DE); Dietrich Scherzer, Neustadt (DE); Christof Möck, Mannheim (DE); Bernhard Vath, Mannheim (DE); Andreas Bode, Mannheim (DE); Ralf Böhling, Lorsch (DE)

Correspondence Address: CONNOLLY BOVE LODGE & HUTZ, LLP, P O BOX 2207, WILMINGTON, DE, 19899, US

(21) Appl. No.: 12/526,430

(22) PCT Filed: Feb. 5, 2008
(86) PCT No.: PCT/EP2008/051400

§ 371 Date: Aug. 7, 2009

(30) Foreign Application Priority Data
Feb. 8, 2007 (EP) 07101966.5

(51) Int. Cl. C08J 9/40; B32B 3/26; F42B 12/00; F28D 20/02

(52) U.S. Cl. 165/104.15; 521/187; 428/321.1; 428/321.5; 102/517

(57) ABSTRACT

A liquid-impregnated shaped foam article consisting of

a) from 1 to 10% by volume of an open-cell foam based on an aminoplast and

b) from 90 to 99% by volume of a component which is liquid at 25° C., such as aromatic or aliphatic hydrocarbons, alcohols, ketones, water or aqueous dispersions, and the uses thereof for transporting or metering liquids, for cleavage through freezing, for energy absorption of projectiles or as latent heat stores.

The invention relates to a liquid-impregnated shaped foam article consisting of

a) from 1 to 10% by volume of an open-cell foam based on an aminoplast and

b) from 90 to 99% by volume of a component which is liquid at 25° C., and the uses thereof.

Open-cell foams based on a melamine/formaldehyde condensate are known for various heat-insulating and sound-insulating applications in buildings and vehicles and as insulating and shock-absorbing packaging material.

The open-cell structure permits the take-up and storage of suitable cleaning agents, abrasives and polishes when used as a cleaning, abrasive and polishing sponge (WO 01/94436).

EP-A 1 498 680 describes an accumulator for maintaining cold and heat and comprising melamine/formaldehyde foam whose cell pores are completely or partly filled with a flowable heat-transfer medium and which has a covering which may consist, for example, of a polyolefin film.

The use of liquid stores comprising open-cell foams based on a melamine/formaldehyde condensate as a fuel tank and for storing and transporting hazardous liquid materials is described in WO 2007/003608.

Pipes, hoses or open or closed containers, such as buckets, bottles, canisters or containers, are usually used for transporting liquids. However, these are frequently rigid, heavy and complicated to fill and empty.

In heat management, it is necessary to meet various requirements both on a small scale, e.g. in electronics, and on a larger scale, e.g. in the case of vehicles. These requirements include a good insulation effect, heat removal and supply by radiation, conduction or convection, damping of temperature variations, avoidance of material fatigue, stable function of sensors or the temporary storage of heat. In addition, the materials used for this purpose must be capable of being applied flexibly and must be stable in their thermal, mechanical and magnetic properties. In the case of heat radiation, special absorption and emission properties must be fulfilled.

It was an object of the invention to bring a component which is liquid at room temperature into a solid form which is easy to transport and from which it can be easily and reversibly converted back at any time into the liquid form. Furthermore, it was intended to find novel applications for liquid components in solid form.

Open-cell foams used are preferably resilient foams based on a melamine/formaldehyde condensate having a specific density of from 5 to 100 g/l, in particular from 8 to 20 g/l.

The cell count is usually in the range from 50 to 300 cells/25 mm. The mean cell diameter is as a rule in the range from 80 μm to 500 μm, preferably in the range of from 100 to 250 μm.

The tensile strength is preferably in the range from 100 to 150 kPa and the elongation at break in the range from 8 to 20%.

For the production, according to EP-A 071 672 or EP-A 037 470, a highly concentrated, blowing agent-containing solution or dispersion of a melamine-formaldehyde precondensate can be foamed with hot air or steam or by microwave irradiation and cured. Such foams are commercially available under the name Basotect® from BASF Aktiengesellschaft.

The molar melamine/formaldehyde ratio is in general in the range from 1:1 to 1:5. For the production of particularly low-formaldehyde foam, the molar ratio is chosen to be in the range from 1:1.3 to 1:1.8 and a precondensate free of sulfite groups is used, as described, for example, in WO 01/94436.

In order to improve the performance characteristics, the foams can subsequently be annealed and pressed. Foams can be cut to the desired shape and thickness and laminated on one or both sides with outer layers. For example, a polymer or metal sheet can be applied as an outer layer.

Owing to the substantial chemical stability of the melamine/formaldehyde condensate, the open-cell foam can also come into contact directly with the various liquids, including cryogenic ones. Even at low temperatures, for example below −80° C., the foam remains resilient. Damage through embrittlement does not occur.

The shape and dimensions of the open-cell foam depend on the intended use. As a rule, the height of the open-cell foam is from 1 to 500 mm, preferably in the range from 10 to 100 mm.

The volume of this foam consists of from 0.5 to 10% by volume of the aminoplast resin and from 90 to 99.5% by volume of air. This air can be expelled by immersion in a liquid, and the liquid-impregnated shaped foam article according to the invention is obtained. A shaped foam article impregnated with water or another liquid accordingly consists of a liquid which can be dimensioned as desired in three dimensions.

Substances which are flowable or pasty at 25° C. and are inert to the aminoplast, for example aromatic or aliphatic hydrocarbons, such as alkanes, benzene, toluene, xylene, alcohols, such as methanol, ethanol, propanol, butanol or hexanol, ketones such as acetone or methyl ethyl ketone, or water, aqueous solutions or dispersions, can be used as the liquid component.

The liquid component has, as a rule, a density in the range from 800 to 1200 kg/m³. There are particularly versatile possibilities of use for water as the liquid component.

The thermal properties of a material are determined in particular by the thermal conductivity and the heat capacity. These properties can be influenced by a suitable combination of materials substantially independently of one another.

Functional liquids, for example an aqueous dispersion of a microencapsulated paraffin mixture, so-called PCMs (phase changing materials), can also be used as the liquid component. The PCM components have as a rule a melting point Tₘ in the range from 20 to 40° C. and have a high enthalpy fusion. They can be processed with the open-cell foam and, if appropriate, additives which change the thermal conductivity, such as metallic powders, to give composite materials for heat management. As a rule, a proportion of PCM is from 10 to 50% by weight based on the composite after removal of the liquid carrier phase. Owing to the capillary forces in the open-cell foam, it is also possible in some cases to use some PCM waxes without encapsulation.

The mechanical stability and the flexibility are ensured by the open-cell foam. The additives are chosen according to the requirements which the electrical and magnetic properties have to meet. The surface of the composite can be coated in order to influence the radiation properties. Such composites can be used, for example, for covering crockery, for example beverage cups or cans or microwave crockery. On introduction of the hot beverage, part of the heat energy is used for melting the PCMs, which releases the heat to the beverage again after falling below the crystallization temperature. if regions with an incompletely filled foam or a multi-layer composite are present, this results in additional heat insulation.

It is also possible to combine the heat-insulating and sound-absorbing properties with those of the unfilled open-cell foam. in the case of partial impregnation or by combination of impregnated and unimpregnated layers of the open-cell foam, thermal insulation is possible, by means of which even temperature peaks can be absorbed. Owing to the flexibility, the open-cell foams impregnated with PCM can be adapted three-dimensionally to any desired shapes and used for effective heat management.

A foam cube impregnated with water and having a height of less than 10 cm does not leak. It behaves like an ice cube which does not melt. Since the liquid-impregnated shaped foam article according to the invention can be cut in an outstanding manner using a sharp knife, it can also be referred to as “sliceable liquid”. From these points of view, there are surprisingly many potential applications.

One potential application of the liquid-impregnated shaped foam article is the simple and accurate metering of the liquid component.

The metering of liquid components plays a role particularly in medicine or cosmetics. For example, a thin alcohol film for disinfecting the skin surface can be uniformly applied by means of alcohol-impregnated shaped foam articles. Other medically active substances can also be applied in a targeted manner to a diseased skin area in this manner. Owing to this slightly abrasive effects of melamine resin/formaldehyde foams, horny skin or dead skin scales can simultaneously be peeled thereby.

The shaped foam articles, also introduced into a commercially available tube, thus permit the dropwise metering of liquid components by slight pressure on the tube.

Exact metering can also be effected by introducing appropriately dimensioned cubes of the open-cell foam. Thus, for example, a concentrated solution of active substance can be sucked up into a cube having the dimensions 1 cm×1 cm×1 cm and then introduced into another liquid. An open-cell foam impregnated with vegetable oil forms a thin oil film on the water surface, which film kills mosquito larvae.

A further potential application for the liquid-impregnated shaped foam article is the simultaneous transport of one or more liquid, components without electrical energy. Between two containers having different water levels, a water-impregnated foam strip equalizes the level without the use of hydrostatic pressure. A filled vessel empties without a hose or suction being necessary. At the same time, cleaning is effected by the filtration effects of the open-cell foam.

The open-cell foam can also be moistened after application and the liquid transport started thereby. In contrast, a hose used as a liquid siphon must first be filled with the liquid, for example by suction. Liquid may run out as a result. Liquid conductors comprising the open-cell foam can be produced by combining individual parts and cut to size three-dimensionally or connected. Compared with filaments or woven fabrics as a liquid transport medium the open-cell foam exhibits simpler handling and can be adapted to a variety of three-dimensional structures.

The liquid-impregnated shaped foam article according to the invention can also be used, for example, in solar collectors. Here, the liquid in the open-cell foam is heated by sunlight and then removed. Cold liquid can be supplied on the other side. The use of pipes is unnecessary as a result. In this application, the combination with radiation-absorbing substances, for example graphite, is expedient in order to achieve faster heating of the water.

The shaped foam article according to the invention is also suitable, for example, for circulating flammable liquids by pumping, for example in the case of accidents involving transport of hazardous materials. Here, a hose-like shaped foam article is impregnated with the hazardous material and can be achieved by gravitation without suction and without the use of mechanical pumps for transporting the leaked liquid to a collecting container provided. For this application, an antistatic treatment of the foam, for example by application of electrically conductive layers, may be advantageous for reducing the danger of sparking.

The liquid streams in the open-cell foam are as a rule very laminar. If the flow velocity is very high, the least mixing is achieved owing to the relatively lower diffusion rate. This can be utilized, for example, for transporting two or more liquid streams parallel through the open-cell foam and for inducing any desired chemical reactions or physical processes, for example complexing, dye formations, precipitations or polymerizations, at the interface.

For example, the liquid streams can be fixed by formation of solids in the interface. As a result of this channel formation, open three-dimensional microfluidic systems or membranes can be produced within the foam. The system functions provisionally for very many completely different reactions.

While open-cell foams based on an aminoplast resin are used for heat and sound insulation, the liquid-impregnated shaped foam article according to the invention is suitable in particular for energy absorption of projectiles. If the transparency is not decisive, the liquid-impregnated shaped foam article according to the invention is also suitable for investigating bullet channels as an alternative to gelatin blocks.

The liquid with which the foam is impregnated may have particular rheological properties, such as, for example, thixotropy or dilatancy, in order to modify the absorption of the liquid into the foam, the discharge power or the energy uptake of the impregnated foam. For example, the foam can be impregnated with a dilatant dispersion. The impregnated foam also has a dilatant effect but can be more easily handled than the dispersion outside the foam.

A further use of the liquid-impregnated shaped foam article according to the invention is cleavage through freezing. For this purpose, the open-cell foam can be inserted into rock fissures or prepared bore holes and impregnated with a liquid, for example water. As a result of frost or cooling, for example by pouring over liquid nitrogen, the liquid in the open-cell foam freezes and, as a result of the volume unit associated therewith, develops a pressure which cleaves the rock. In addition to rocks, other stones and materials, for example concrete, wood, metal or brittle plastics, can also be cleaved in this manner.

The foam impregnated with liquid can advantageously be used for protection from fires or for fighting fires. For example, flames can be extinguished with impregnated foam probes, the liquid being unable to escape from the focus of the fire by flow. The foam can also be continuously remoistened. For example, the application of foam layers on walls of buildings, for example in a double casing, is conceivable. In the dry state, this layer serves for thermal insulation, In the case of a fire risk, the layer is continuously moistened via a feed pipe system and increases the fire protection of the building.

### EXAMPLES

For the following examples, an open-cell melamine/formaldehyde foam having a density of about 10 kg/m³ (Basotect® from BASF Aktiengesellschaft) was used.

### Example 1 (Capillary Rise)

A dry Basotect® test specimen was placed in a beaker filled with water. Owing to the capillary forces in the interior of the test specimen, the liquid rose to a height of about 1 cm above the liquid level. If a Basotect® test specimen completely impregnated with water was placed in the water, the liquid was retained in the interior of the test specimen to a height of about 8-12 cm above water level. In the case of a higher water column, the excess height of water ran out of the sample to this value. Water was retained in the interior of the Basotect® up to a water column about 12 cm high.

### Example 2 (Siphon)

A beaker was filled with water. A second beaker comprised no liquid and was positioned next to the first beaker at the same height. A Basotect® nonwoven (thickness about 5 mm, width about 7 cm) was first completely impregnated in water and then one end thereof was dipped into the beaker filled with liquid while the other end ended in the empty beaker. The height difference between the maximum elevation of the foam and the liquid level is less than 12 cm, in order to prevent the water from running out with drying of the foam. Transport of the liquid from the filled beaker into the empty vessel was observed until the height of the water level in the two vessels was equal. If one of the beakers was raised after the equilibrium had been established, transport of the liquid began again until the two liquid levels were at the same level.

The transport of the liquid was also observed if an initially dry nonwoven was used and, after bridging of the two vessels, was completely moistened with the aid of a spray bottle until the liquid exchange began.

Instead of a foam body, it is also possible to use a plurality of individual pieces of Basotect® which are both connected in order to permit liquid transport. When the nonwoven in the above example was cut through with scissors at the highest point, the liquid transport stopped. When the cut edges were connected by means of a paper clip, the equalization of the liquid level started again.

### Example 3

Three rectangular blocks of Basotect® are impregnated in water. One block was placed in the empty vessel and one block in the vessel with water. The third block was placed transversely on the two upright blocks. When all three blocks are in contact, the liquid transport begins at a comparatively high flow rate.

### Example 4 (Laminarity)

A beaker was filled with water stained blue. A second beaker was filled with water stained red. The two beakers were placed on an approximately 10 cm high underlay. Before this underlay, i.e. at a lower level, a third, empty beaker was placed. A Basotect® nonwoven (thickness about 5 mm, width about 10 cm; length about 40 cm) was incised in the middle over a length of about 20 cm. The nonwoven obtained was thus divided into two strands of approximately equal width after half the length. The nonwoven was completely impregnated with water. The two narrow ends were then each dipped into the water stained blue and that stained red, while the broad end ended in a lower, empty vessel. It was observed that water stained red and blue flowed through the nonwoven into the lower vessel. Surprisingly, no mixing of the two dye solutions within the impregnated foam was observed. With a sufficiently high flow rate, a blue liquid stream and a red liquid stream ran side by side through the foam sample and did not mix until emerging from the foam in the collecting vessel. Liquid streams in Basotect® are very laminar. If the flow velocity is very high, the least mixing is achieved owing to the relatively lower diffusion rate.

### Example 5

A vessel with water and an empty vessel were connected by a water-impregnated nonwoven comprising Basotect® so that liquid transport occurs. Three small drops of a highly concentrated aqueous solution of a blue dye were placed on the nonwoven with a horizontal spacing of about 2 cm at the same height using a fine pipette. The way in which three stained liquid streams which did not mix within the impregnated foam formed side by side was observed. A chemical reaction/physical process can occur at the contact surface of the laminar flows.

### Example 6

Example 5 was repeated but, instead of stained water, two liquids which showed chemoluminescence on contact were used. The system began to luminesce in the contact region of the two streams.

### Example 7

Instead of two liquids provided with different dyes, a 0.1 N aqueous sodium hydroxide solution and a 0.1 N aqueous hydrochloric acid which comprised about 5% of phenolphthalein were used, and the procedure was analogous to example 5. From the region of the nonwoven where the two individual strands combined, the formation of a violet boundary layer occurred owing to a color change of the pH indicator from the initially colorless solutions. The color change occurred only in the region of the boundary layer. The width depended on the flow rates.

### Example 8

Instead of two liquids provided with different dyes, a 10% strength aqueous solution of a sodium silicate (waterglass) and a 10% strength phosphoric acid solution were used, and the procedure was analogous to example 5. From the region of the nonwoven where the two individual strands combined, the formation of a solid occurred. The solid formation occurred only in the region of the boundary layer.

### Example 9 (Water Cube)

A cube of Basotect® (7×7×7 cm) was immersed in water. The water was retained in the interior of the foam and did not run out. A razorblade was fastened to a plastic sheet (e.g. of PE) so that the sharp sides of the blade stood perpendicular to the surface. The surface of the shape was moistened with a soap solution so that it had a slight frictional resistance. The Basotect® cube impregnated with water was placed on the plastic sheet treated in this manner. When one end of the sheet was raised so that the cube slipped onto the fixed blade, the moving cube was cut into two parts by the blade. In a comparative experiment with dry Basotect, the cube could not be cut in this manner. Basotect® can be cut better, more precisely and without dust if it is wet.

### Example 10

A rectangular test specimen of Basotect® (7×5×20 cm) was impregnated in water and stood on the base surface of 7×20 cm. Water did not run out. The test specimen was raised on the side having a width of 7 cm so that the height of the total perpendicular water column rose above a value of about 10 cm. Water ran out of the foam until the level fell below this value. Water absorption and release can be controlled by the orientation of the impregnated test specimen.

### Example 11

An impregnated water cube (2×2×2 cm) was cooled below 0° C. in an ice box. The water in the interior of the cube froze without destroying it. On longer storage in the ice box, roughening of the surface occurred through partial sublimation of the ice. The rough ice cubes were easy to handle since they did not slip out of the hands. When the ice cubes were removed from the ice box, the water thawed, the melt water remaining in the interior of the Basotect® block.

### Example 12 (Siphon Bottle)

The bottom of a conventional 1.5 l PET beverage bottle was cut off so that the lower part consisted of an open cylinder having a diameter of about 7 cm. The bottle closure was retained. A disk of Basotect® having an adapted diameter and a height of about 1.5 cm was fitted into the opening. The closure of the bottle was opened and the bottle was immersed with the bottom closed by means of Basotect about 5 cm into a vessel filled with water. Water penetrated into the interior of the bottle through the Basotect® disk, a corresponding amount of air escaping through the opened closure. When the bottle with the opened closure was raised, the liquid present above the Basotect® disk flowed out of the bottle. When the closure of the bottle was closed after entry of the water, no liquid ran out after removal of the bottle from the water since no gas exchange can take place. When the closure was then opened, the water could run out of the bottle. The release of the water can be controlled by the gas exchange.

### Example 13 (Energy Absorption of an Air Gun Projectile)

An air gun (caliber 4.5 mm, Diabolo; E0<7.5 J, V0<175 m/s) was fired at a block of polystyrene particle foam (Styropor®, 5×5×5 cm), a block of dry Basotect® (5×5×1 cm) and a corresponding block of water-impregnated Basotect®. The Styropor® block flew away from its original location after being hit. The projectile scarcely penetrated into the material, which absorbs the energy as a total body. Dry Basotect® remained at the original location after being fired at. The projectile passed through the test specimen, a chaotic, frayed bullet channel being formed and pulverized Basotect® being present behind the test specimen. On firing at impregnated Basotect®, the latter likewise remained at its original location. The bullet channel consisted of a cleanly punched out hollow cylinder. A completely preserved Basotect® cylinder from the bullet channel was present behind the test specimen.

### Example 14 (Latent Heat Store)

A test specimen of Basotect® (100·80·3 mm, 0.35 g) was impregnated with an aqueous dispersion of a microencapsulated paraffin mixture which has a melting point of 28° C. (Micronal, BASF AG). After drying of the dispersion, the total mass of the impregnated foam nonwoven was 8.5 g. The material obtained is mechanically flexible, has pleasant haptic properties and, on contact with the body, cools through the enthalpy of fusion consumed on melting of the paraffin crystallites.

1.-11. (canceled)

12. A liquid-impregnated shaped foam article consisting of
a) from 0.5 to 10% by volume of an open-cell foam based on an aminoplast and
b) from 90 to 99.5% by volume of a component which is liquid at 25° C.

13. The liquid-impregnated shaped foam article according to claim 12, wherein the liquid component is an aromatic or aliphatic hydrocarbon, alcohol, ketone or water.

14. The liquid-impregnated shaped foam article according to claim 12, wherein the liquid component is an aqueous dispersion of a microencapsulated paraffin mixture.

15. The liquid-impregnated shaped foam article according to claim 12, wherein the open-cell foam has a specific density in the range of from 5 to 100 kg/m³ and the liquid component has a density in the range of from 800 to 1200 kg/m³.

16. The liquid-impregnated shaped foam article according to claim 14, wherein the open-cell foam has a specific density in the range of from 5 to 100 kg/m³ and the liquid component has a density in the range of from 800 to 1200 kg/m³.

17. The liquid-impregnated shaped foam article according to claim 12, wherein the open-cell foam was produced from a melamine/formaldehyde condensate having a molar melamine/formaldehyde ratio in the range of from 1:1 to 1:5.

18. The liquid-impregnated shaped foam article according to claim 16, wherein the open-cell foam was produced from a melamine/formaldehyde condensate having a molar melamine/formaldehyde ratio in the range of from 1:1.3 to 1:1.8.

19. A process for metering the liquid component which comprises utilizing the liquid-impregnated shaped foam article according to claim 12.

20. A process for simultaneously transporting one or more liquid components without electrical energy which comprises utilizing the liquid-impregnated shaped foam article according to claim 12.

21. A process for energy absorption of projectiles which comprises utilizing the liquid-impregnated shaped foam article according to claim 12.

22. A process for cleavage through freezing which comprises utilizing the liquid-impregnated shaped foam article according to claim 12.

23. A latent heat store which comprises the liquid-impregnated shaped foam article according to claim 12.

24. A process for the production of a latent heat store, wherein the liquid-impregnated shaped foam article according to claim 14 is dried.
